(19) United States
(12) Patent Application Publication
(10) Pub. No.: US 2002/0082825 A1
(43) Pub. Date: Jun. 27, 2002

(54) Method for organizing and using a statement library for generating clinical reports and retrospective queries

(75) Inventors: Gordan lan Thomas Rowlandson, Milwaukee, WI (US); Carol Thompson Tumey, New Berlin, WI (US); Daniel Mark Saar, Hartland, WI (US)

Correspondence Address: Alistair K. Chan, FOLEY & LARDNER, Firstar Center, 777 East Wisconsin Avenue, Milwaukee, WI, 53202-5367, US

(73) Assignee: GE Medical Systems Information Technologies, Inc.

(21) Appl. No.: 09/748,660

(22) Filed: Dec. 22, 2000

(51) Int. Cl. G06F 17/27

(52) U.S. Cl. 704/9

(57) ABSTRACT

A method for organizing and using a statement library and generating clinical reports is disclosed. The method disclosed may include accessing a first medical statement from a statement library the first medical statement including a first grammatical characteristic identifier. The method may also include accessing a second medical statement from the statement library the second medical statement including a second grammatical characteristic identifier. Further, the method may include identifying the grammatical characteristics of the first and second medical statements and assembling the first medical statement with the second medical statement according to the grammatical characteristics of the first medical statement and the second medical statement, into a text block.

Further disclosed is a method for organizing a statement library, the statement library including a plurality of statements, each statement having statement text, a statement number, and a statement acronym. A method of organizing a statement library may include associating each statement to at least one statement grouping, associating each statement to a plurality of statement attributes, associating key words to at least one statement grouping and statement numbers, and associating each statement with other statements.

### FIELD OF THE INVENTION

The invention relates generally to the field of data management. More particularly, the invention relates to the use of and organization of a statement library, particularly a medical statement library. Further, the invention relates to the generation of clinical reports using statements from a medical statement library.

### BACKGROUND OF THE INVENTION

Database systems for allowing the efficient recordation of information are known. For example, the MUSE® system, available from GE Marquette of Milwaukee, Wis., uses a statement library from which a physician or a technician may generate and edit a clinical report such as an electrocardiogram (ECG) interpretation. The ECG statement library on the MUSE® system includes more than a thousand medical statements. Each medical statement is associated with a statement number and an acronym. Further, ECG interpretations or ECG clinical reports may be automatically rendered by the MUSE® system by converting statement numbers that are output by an interpretation program into statement text that is associated with the statement numbers in the statement library. Further, customers, such as physicians and hospitals, may add their own statements to the statement library by referencing a unique statement acronym from the library. After the user has added their own statements, the computer renders a complete text associated with the acronym.

An inherent difficulty with the use of such statement libraries is that physicians often have difficulty locating the correct acronym from the statement library to use. Although the acronyms may be presented in alphabetical order, the lists may be very long and accordingly, time consuming to navigate. Furthermore, the correct first letter of an acronym is often not what comes to mind when searching for a particular clinical condition in the statement library.

Searching clinical reports generated by the above described statement libraries also produce certain difficulties. For example, searches for particular clinical findings, represented in the form of statement numbers, are often very difficult to accomplish. A particular clinical finding may be associated with multiple statements. For example, acute myocardial infarction (AMI) is associated with over 20 different statement numbers. To find all patients with AMI, the search mask should contain the logical “OR” of the 20 different statements. Further, the person setting up the search would have to know that there were over 20 different statements for AMI and would have to know what those statements were. If the user was not aware of the 20 different statements for AMI, a search with just a single statement for AMI would render seemingly reliable results and yet not cull all the pertinent records associated with AMI.

Referring to FIG. 1, a statement library 100 of the prior art is depicted having a plurality of statements 110 forming the statement library. Statement library 100 is typically configured as a computer readable data base stored on any of a variety of computer readable sources, such as, but not limited to, memory devices, storage devices, hard disk drives, CD ROM drives, optical disk drives, floppy disk drives, tape drives, and the like. Each of statements 110 includes a statement number 120, a statement acronym 130, and statement text 140. In an embodiment of the prior art, the statements in the statement library have statement number 120 which is associated with statement acronym 130 and statement text 140. Statement library 100 is used and accessed by the physician or technician to generate and edit a clinical report, such as an ECG report. In one use of statement library 100, a user, such as a physician or technician, recalls a statement by inputing or selecting a statement acronym. Statements recalled by statement acronym may be accessed by or through an alphabetical list of statement acronyms. Further, physicians or technicians who are extremely well versed in the statement library may access statements directly by statement number. In one exemplary use, a computer analysis program is used to extract statement numbers in a statement library, according to medical measurements made, such as, but not limited to, an ECG.

For example, referring to FIG. 2, a system for generating a report 150 is disclosed. An expert analysis program, for example the 12SL® program available from GE Marquette of Milwaukee, Wis., is used to analyze ECG data. Expert analysis program 155 may be configured to analyze any of a variety of patient information data. Expert analysis program 155 analyzes the patient information data and exports a plurality of statement numbers or codes 160. The statement numbers 160 are exported to a report generator 165. Report generator 165 communicates with a statement library 170 and converts codes into text strings 175 by accessing the statement in statement library 170 corresponding to each statement number 160 to elicit statement text 175. Report generator 165 therefore generates a report 180 which is comprised at least in part of text string statements 175. Statement numbers 160 are then stored, and may be searched, retrieved and read by physicians, technicians and/or other users.

Accordingly, there is a need for a method of organizing a statement library in which statements are associated with a plurality of attributes to provide for simplified searching and access. There is also a need for a method of interacting with a cardiographic statement library in which statements may be accessed through key words and statement groupings. Further, there is a need for a method of generating clinical report text in which the clinical report is generated according to grammatical characteristics of the medical statements being assembled. Yet further still, there is a need for a method of generating a clinical report through a computer user interface in which a user is provided access to a plurality of filtered medical statements, the filtered medical statements being based on characteristics of prior medical statements.

The teachings herein below extend to those embodiments which fall within the scope of the appended claims, regardless of whether they accomplish one or more of the above-mentioned needs.

### SUMMARY OF THE INVENTION

An exemplary embodiment of the invention relates to a method of organizing a statement library. The statement library includes a plurality of statements, each statement having statement text, a statement number, and a statement acronym. The method includes associating each statement to at least one statement grouping. The method also includes associating each statement to a plurality of statement attributes. Further, the method includes associating key words to at least one of statement groupings and statement numbers. Further still, the method includes associating each statement of the statement library with other statements in the statement library.

Another exemplary embodiment of the invention relates to a method of interacting with a cardiographic statement library. The cardiographic statement library includes a plurality of statements, each statement having statement text, a statement number, and a statement acronym. The method includes providing a key word. The method also includes accessing a statement grouping associated with the key word. Further, the method includes selecting a statement from the statement grouping.

Yet another exemplary embodiment of the invention relates to a method of generating clinical report text. The method includes accessing a first medical statement from a statement library the first medical statement including a first grammatical characteristic identifier. The method also includes accessing a second medical statement from the statement library the second medical statement including a second grammatical characteristic identifier. Further, the method includes identifying the grammatical characteristics of the first and second grammatical statements. Further still, the method includes assembling the first medical statement with the second medical statement according to the grammatical characteristic identifiers of the first medical statement and the second medical statement, into a text block.

Yet still another exemplary embodiment of the invention relates to a method of generating a clinical report through a computer user interface. This method includes selecting a first medical statement from a medical statement library. The method also includes providing to the user access to a plurality of filtered medical statements based on the first medical statement. The filter is based on at least one of a grammatical characteristic of the first medical statement, a key word, an acronym, and a grouping identifier. Further, the method includes selecting a second medical statement from the plurality of filtered medical statements.

Yet further still, another exemplary embodiment of the invention relates to a method of making a clinical assessment. The method includes generating a plurality of medical statements from a statement library based on clinical measurements. At least some of the medical statements in the statement library are associated with a diagnostic predictor. The method also includes analyzing the diagnostic predictors from the plurality of medical statements. Further, the method includes, as an output, a clinical assessment based on the analysis of the diagnostic predictors.

### BRIEF DESCRIPTION OF THE DRAWINGS

The invention will become more fully understood from the following detailed description, taken in conjunction with the accompanying drawings, wherein like reference numerals refer to like elements, in which:

FIG. 1 is an exemplary diagram of a statement library structure of the prior art;

FIG. 2 is a diagram depicting report generation using an expert analysis program and a statement library of the prior art;

FIG. 3 is an exemplary diagram depicting configurability of statements in the statement library;

FIG. 4 is an exemplary diagram depicting additional attributes associated with a statement of the statement library;

FIG. 5 is an exemplary diagram depicting groupings associated with a statement of the statement library;

FIG. 6 is an exemplary diagram depicting a statement library browsing interface;

FIG. 7 is an exemplary diagram further depicting the statement library browsing interface;

FIG. 8 is an exemplary diagram depicting possible associated attributes depending on the group selected;

FIG. 9 is an exemplary diagram depicting a clinical data entry form depicting changes in selectable attributes dependent on the data entry field selected;

FIG. 10 is an exemplary diagram depicting hyperlink associations with documents and the statement library;

FIG. 11 is an exemplary diagram depicting the association of statements in the statement library with other statements in the statement library;

FIG. 12 is an exemplary diagram depicting the listing of all statements in the statement library associated with a specific grouping;

FIG. 13 is an exemplary diagram depicting an additional diagnostic classification attribute of a statement in the statement library; and

FIG. 14 is an exemplary flow diagram depicting the steps in generating a diagnostic classification.

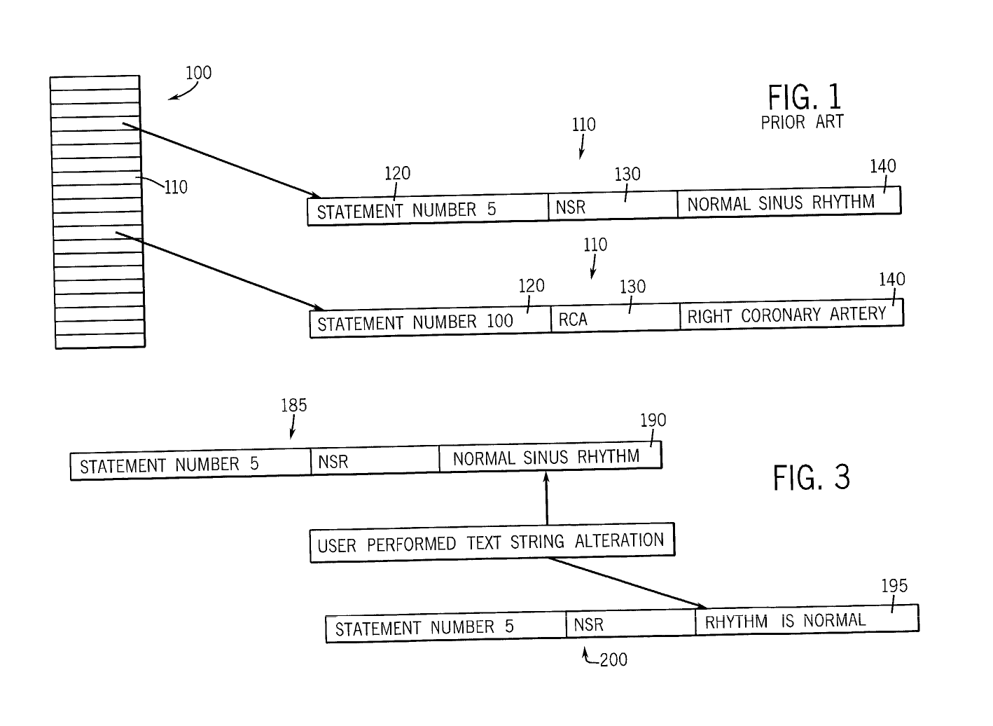

### DETAILED DESCRIPTION OF THE PREFERRED EMBODIMENTS

In a particular embodiment, depicted in FIG. 3, statements 185 from a statement library such as, but not limited to, statement library 170 may have configurable statement text 190. Configurable statement text 190 may be configured by a user to provide something other than the default statement text. For example, as depicted in FIG. 3, a user may be able to change the statement text without changing any of the associated code and/or the statement number or acronym. Reports generated using, for example, statement number 5 as depicted in FIG. 3 will generate reports using the altered text string 195 of altered statement 200. As depicted in FIG. 3, statement number 5 having acronym NSR for default statement text “normal sinus rhythm” which is text string 190 has been altered by the user into statement 200 in which statement 200 still utilizes statement number 5 with acronym NSR; however, the text string 195 has been altered such that it reads “rhythm is normal.”

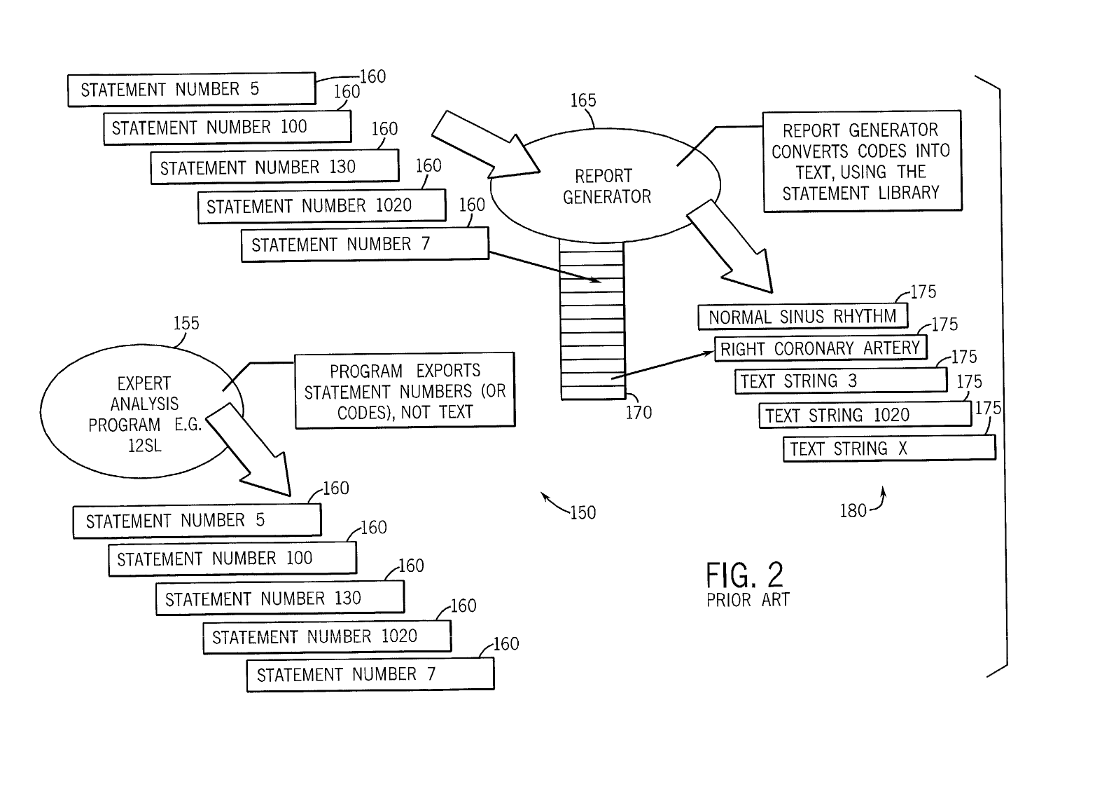

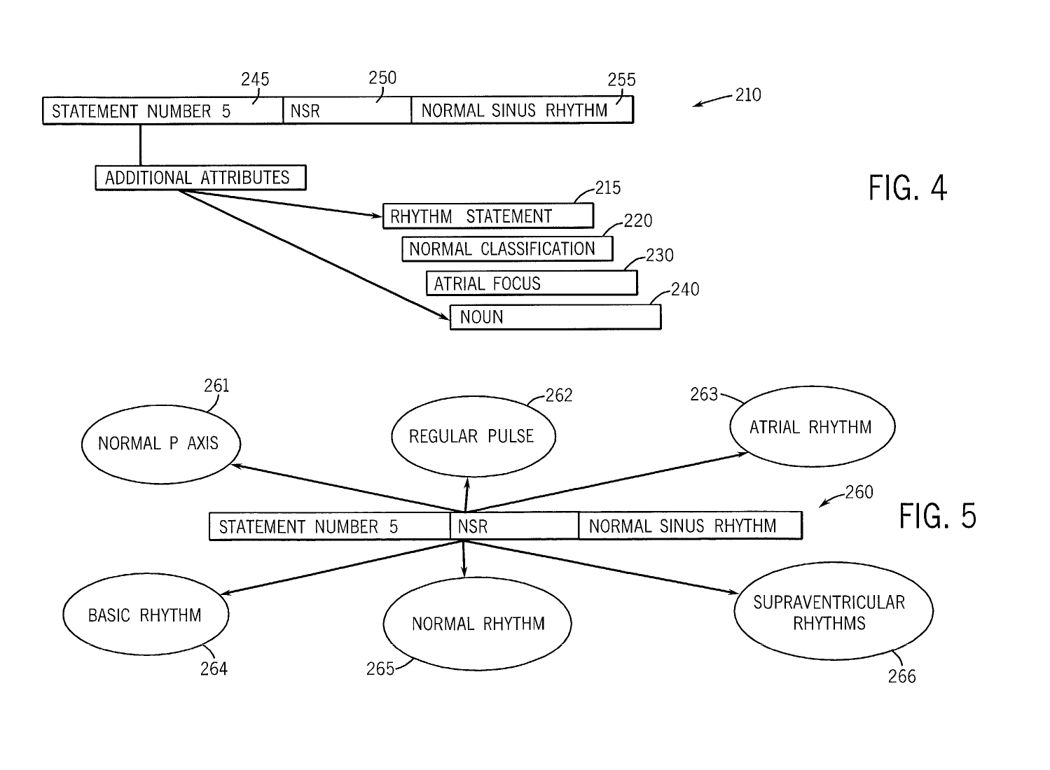

Referring now to FIG. 4, statement 210 is depicted. Statement 210 may be in an exemplary embodiment associated with additional attributes such as statement type, shown as rhythm statement 215; classification, shown as normal classification 220; grouping, shown as focus 230; and grammatical characteristics or part of speech, shown as noun 240. In an alternative environment, a plurality of other types of attributes and different numbers of attributes may be associated with statements such as statement 210. In searching a statement library, such as statement library 170, statements may be found by attributes, such as attributes 215, 220, 230 and 240. Accordingly, because statement 210 is associated with plurality of other attributes as opposed to statement number 245, acronym 250 and statement text 255, the process of searching for specific statements is simplified. For example, should the physician or user know that they are looking for a rhythm statement, for example, statement 210 will be one of a plurality of statements that are displayed which are classified or have the attribute rhythm statement. Further, the grammatical characteristic 240 may be used to aid in the generation of reports by a report generating program such as, but not limited to, report generator 165 depicted in FIG. 2, report generator 165 being configured in such a way as to use attributes in report generation. Any variety of grammatical characteristics may be specified including, but not limited to, parts of speech such as noun, verb, adjective, etc. By utilizing or identifying attributes such as grammatical characteristic 240, report generator 165 properly configured may be enabled to generate a report which results in a smoothly flowing narrative text, as opposed to a disjointed listing of medical statements and further facilitates translations into foreign languages.

As depicted in FIG. 5, a statement, such as statement 260 from a statement library 170, may be associated with a plurality of groups such as exemplary groups 261, 262, 263, 264, 265 and 266. Exemplary groups 261-266 are used to aid the physician or user in finding specific statements. For example, should a physician want to review all the statements in the regular pulse group 262, statement 260 would be listed along with a plurality of other statements associated with regular pulse group 262. Statements may be grouped or clustered based on a plurality of categories. Each statement, such as statement 260, may have multiple groups associated therewith. Groups further may be nested within other groups which aid in navigation and classification. For example, normal rhythm group 265 may be nested within a rhythm group. Should the physician or user be looking for rhythm statements, the physician or user would be provided with a listing of rhythm statements within statement library 170 as well as being provided with subgroups, such as normal rhythm 265. In an exemplary embodiment, groupings, such as groupings 261-266, may be reconfigured through a statement library editor. Groupings further may be used by a user interface which allows navigation to a desired statement simply by identifying the proper grouping either via voice recognition, natural language software used to constrain interpretation of subsequent words and phrases, or by simple user interactions as through an input device such as, but not limited to, a keyboard or a mouse.

An example of major groupings which may be used by statement library 170 may include clinical finding groupings, such as, but not limited to, AMI: hypertrophy, cardiomyopathy, etc.; overall classification: normal, abnormal, etc.; test type: cath, echo, ECG, etc.; anatomy: atria, ventricular, etc.; etc. Examples of minor groupings may include wall motion, ST/T abnormality, blocks, ectopic beats, rhythm statements, conduction statements, and the like. Statements in statement library 170 may further be associated with different coding schemes, for example, CPT code, SNOMED code, UMLS code, etc. Further, statement 260 may be characterized as different types of statements including phrases, sentences, paragraphs, templates, etc. Further still, statement 260 may be categorized by grammatical characteristics, such as noun, verb, adverb, adjective, suffix, etc. Utilizing the grammar identifier or grammatical characteristic, a computer program may be configured to combine statements into narrative text as well as use the parts of speech to aid in query generation.

Incorporating a plurality of attributes, groupings and clusterings into the statements of a statement library provides advantageous mechanisms to generate, edit, view and search data either within the statement library or within search reports that have been or are being generated. Often it is desired by a user to perform a retrospective query in which a plurality of clinical reports are searched for a selected condition and/or characteristic, etc.

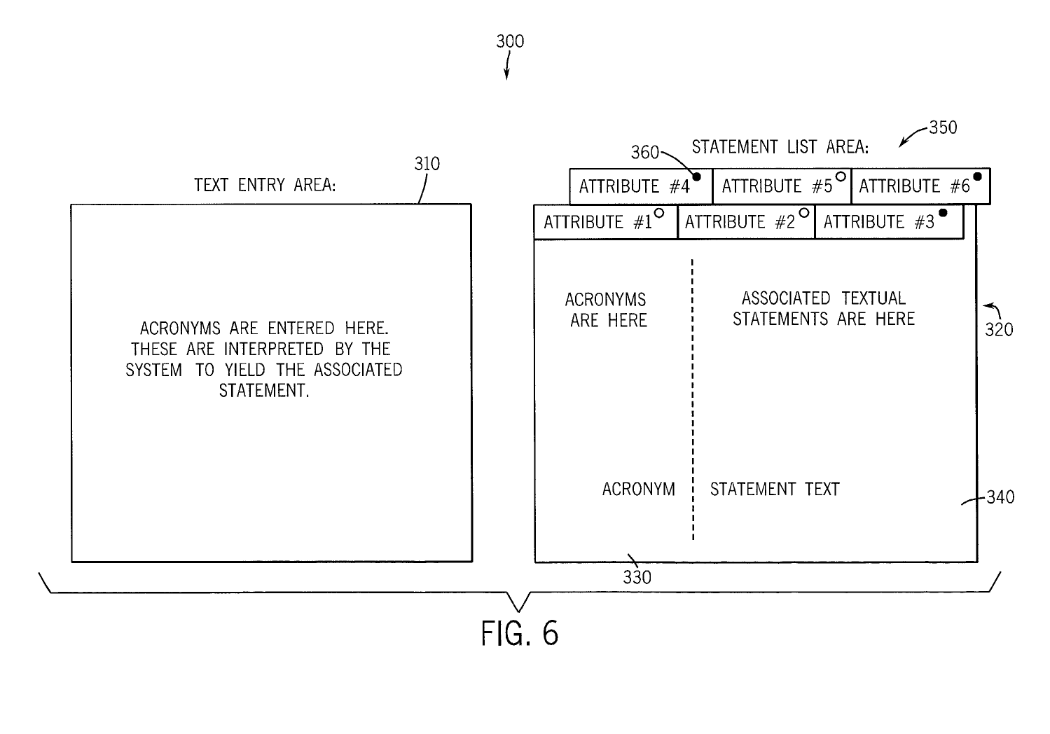

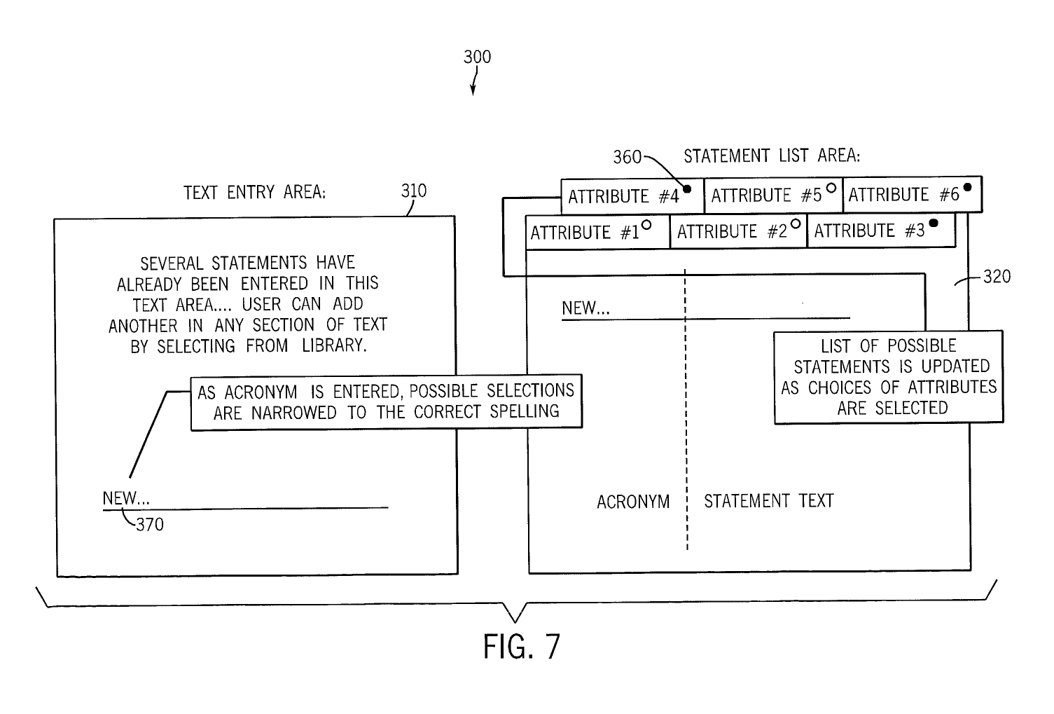

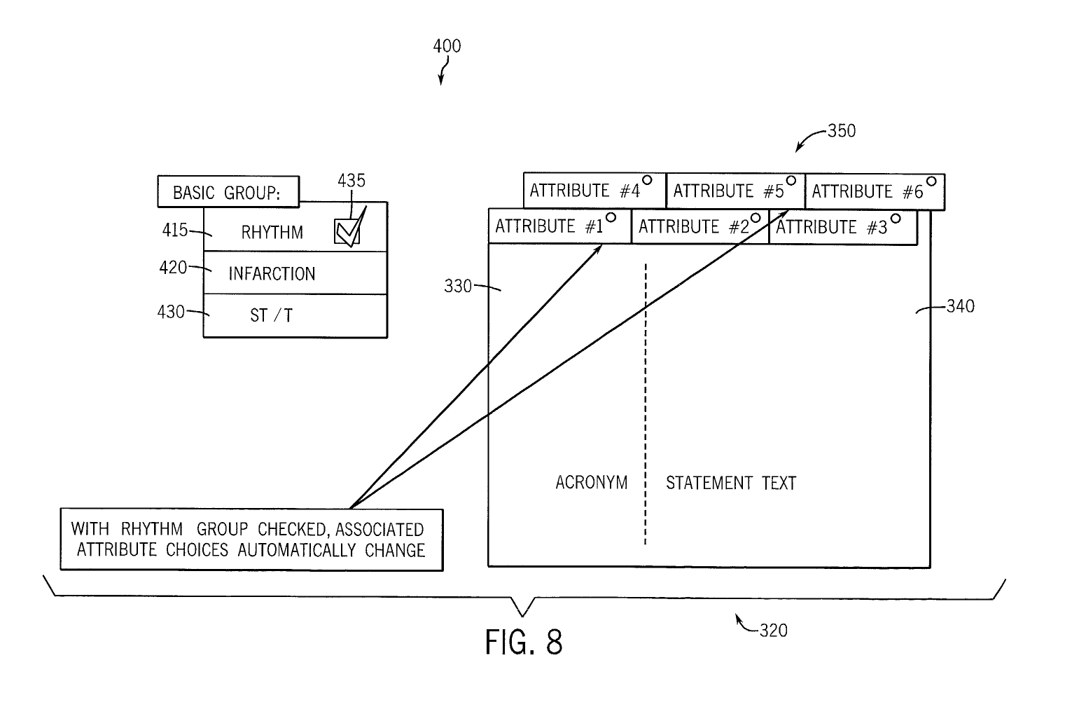

Referring now to FIG. 6, an exemplary layout of a browser interface 300 including a text entry window 310 and a statement list area 320 is depicted. Statement list area 320 includes a plurality of statements listed with acronyms in an acronym area 330 and associated statement text in statement text area 340. Referring to FIG. 8, when a user selects a group, such as rhythm 415, a plurality of attributes in attribute display area 350 are displayed, those attributes being associated with the selected group. A user may then select attributes in attribute display area 350 by clicking on and causing, for example, the darkening of an indicator button 360, as exemplified in FIG. 7. As depicted in FIG. 3, attributes #4, #6 and #3 have been selected. Accordingly, statements having attribute #'s 3, 4, and 6 will be displayed in statement list area 320. Text entry area 310 provides a user a location in which to enter acronyms that are interpreted by the system to yield the associated statement. If, for example, an acronym is known, a user just enters the known acronym 370 in text entry area 310 as depicted in FIG. 7. Alternatively, if a user sees a desired statement in statement list area 320, the statement may be selected through a mouse click, input on a touch screen, keyboard input, or the like and the statement will be automatically displayed in text entry area 310. If the user does not know the acronym, the user may find the acronym through statement list area 320 where lists of possible statements are provided by the user selecting a variety of attributes using selection buttons 360. As a user selects various attributes, the list of possible statements is updated with those statements which are associated with the selected attributes.

Referring now to FIG. 8, an exemplary browsing interface 400 is depicted. Interface 400 includes an acronym area 330 and a statement text area 340, as depicted in FIG. 6. Further, a plurality of attributes 350 are displayed. A group listing 410 is also displayed. Group listing 410 includes exemplary groupings, such as, but not limited to, rhythm 415, infarction 420, and ST/T 430. In an exemplary embodiment depicted, rhythm grouping 415 has been selected via a check box 435 and accordingly attribute listing 350 is automatically changed to display attributes associated with statements in rhythm grouping 415. In the exemplary embodiment depicted in FIG. 8, a physician or user may search for statements according to basic grouping, for example, a user will select the basic grouping rhythm 415 and associated statements will be listed in statement list area 320 showing an acronym and acronym area 330 and associated statement text in statement text area 340. Further, as the physician or user selects the basic group, the associated attribute choices will be shown automatically in attribute listing 350. Therefore, as a physician or user is searching for a statement, the physician or user may have the basic functional group to which the statement that they are searching for should belong but does not know the proper acronym. Accordingly, an alphabetical list would be of no use to the physician or user, however, a group based statement listing would provide an efficient means for a physician or user to locate the proper statement.

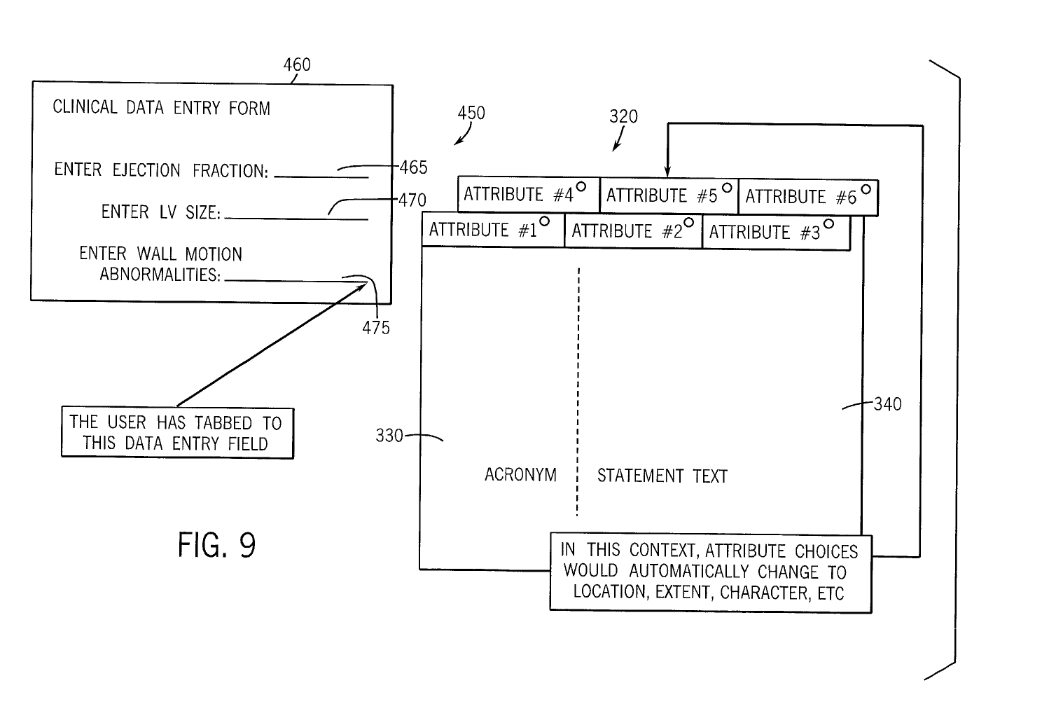

Referring now to FIG. 9, a browser interface 450 is depicted. Browser interface 450 may be displayed when a user has selected from statement list area 320 a specific medical statement having an acronym displayed in acronym area 330 and associated statement text displayed in statement text area 340. Certain medical statements may require additional data entry such as medical measurements. In the exemplary embodiment depicted, a clinical data entry form 460 is displayed in which the user is queried to enter certain medical data such as, but not limited to ejection fraction 465, LV size 470, and wall motion abnormalities 475. A user may input data by any of a variety of input methods depending on the software and hardware configurations used, such as, but not limited to, tabbing to the appropriate field 465, 470, or 475, clicking on the appropriate area with a mouse, selecting the appropriate area with a finger or stylus used on a touch screen, or using appropriate voice commands to move to the appropriate field. In an exemplary embodiment, a user may select an appropriate field to enter data, for example, a user may choose to enter wall motion abnormalities 475. In such an instance, attribute list 320 will display a potential list of associated attributes, such as, but not limited to location, extent, character, etc. that may be entered into field 475. In an exemplary embodiment, a user may select the appropriate attribute from attribute list 320 which will be automatically input to field 475. The use of a clinical data entry form for appropriate medical statements and an automatically adjusted attribute statement further aids the physician or user in efficiently entering medical data into a clinical report.

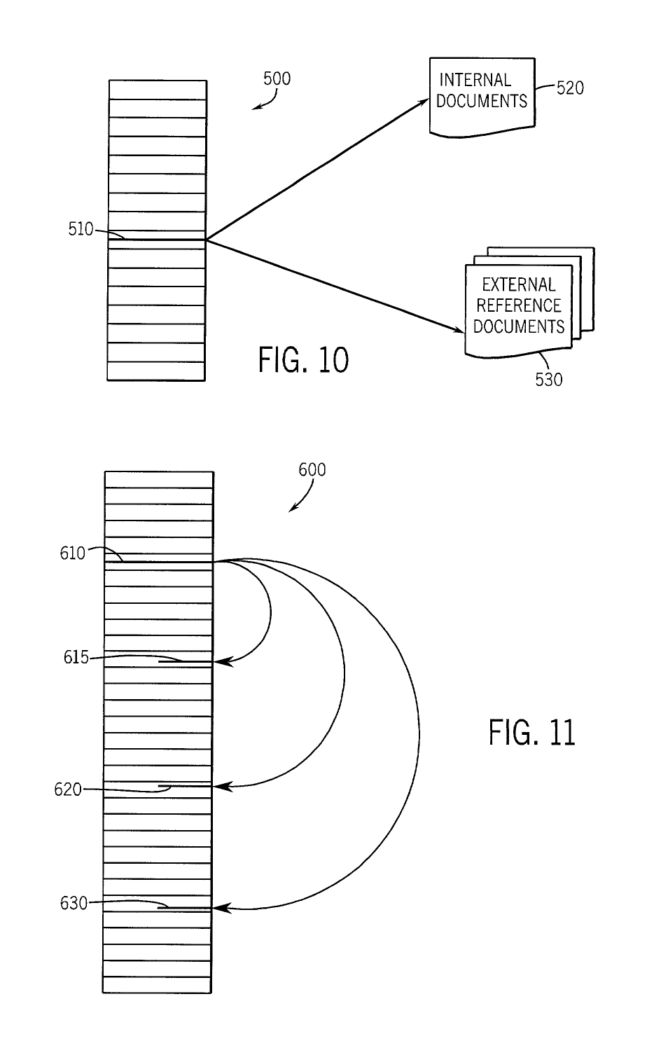

Referring now to FIG. 10, a statement list 500 is depicted, statement list 500 may be a statement list such as a statement list located in statement list area 320 of FIGS. 7-9 or may be any other format of statement list displayed to a user. Statement list 500 depicts a situation in which a selected statement is associated with referenced documents located within the communications network to which the host computer is connected, or possibly is located elsewhere. In an exemplary embodiment, statement list 510 selected from statement list 500 includes a hyperlink to internal documents 520 which may be internal to the hospital or clinic hosting statement library 500. Further, in an exemplary embodiment, statement 510 may include a hyperlink or other reference to external reference documents 530 which may be available through the world wide web (internet), through an intranet, or having a link to other data sources, such as another computerized database and/or library. Reference documents 530 may include, but are not limited to, documents, document fragments, images, video clips, audio clips, and other data sources. A user of statement library 500 may then efficiently gather information related to medical statement 510 if the user needs further information or is unaware of the use of medical statement 510.

In further exemplary embodiments, each statement may include user definable information such as formatting information, that is information in which parts of the statement may be placed in different fonts or different font styles such as bold, italics, special fonts, etc. Further, formatting of statement text may also be generically defined using a hypertext mark up language (HTML), semantics such as emphasis, heading, end of thought, etc.

Further, in an exemplary embodiment, statements in the statement library may be associated with grammatical usages of the statement, that is parts of speech and/or grammatical characteristics. For example, statements in the statement library may be assigned parts of speech, that is, for example, noun, verb, adjective, etc. Having such grammatical use associations for each statements eases foreign language translation for the statement library. For example, expert programs need not be rewritten for use with a particular verbal and/or foreign language. The statement library and report generator will be able to carry out the tasks that they are designed for without having extra programs because knowledge of parts of speech is incorporated into the statement library itself. Further, negative adjunctive clauses, that is statements like “no longer present”, “not present”, “not evident”, etc. may be identified to properly assess search results. For example, when performing a retrospective query of a plurality of clinical reports, it may be desirable to search for clinical conditions which are not present. Incorporating negative adjunctive clauses into the statement library allows such searching ability.

Statements in the statement library, may, in an exemplary embodiment, include links to data entry and calculations. A statement selected from the statement library may result in the system asking for further data entry automatically, for example, as depicted in FIG. 9. Further, use of such a statement may result in automatic calculations being made for the user.

In an exemplary embodiment statements in the statement library may be associated with specific data ranges. For example, a statement may be associated with a data value. An acceptable data range for that value may be defined within the statement itself. For example, the statement may include “normal heart rate” (60-100 beats per minute). These data ranges may be used by expert systems to determine if an associated data value is within the range for the statement hence the expert system may select the statements based on the data range.

Further, in an exemplary embodiment, abbreviated text may be associated with statements of the statement library. For example, beyond the use of the acronym, a statement may be associated with abbreviated statement text. Abbreviated statement text assists in viewing the report as it is being built. For example, the original statements used may be lengthy and may take up a significant amount of screen or display real estate. Therefore, abbreviated text associated with the statement may be useful to the physician such that a plurality of statements in the report may be viewed in an abbreviated form simultaneously. Further, abbreviated text may be useful with clinical reports accessed through bandwidth limited applications, such as, but not limited to, access through digital pagers, digital cellular telephones and text to speech interfaces. For example, the original statement may read, in some length, “Patient history and physical examination were normal. Ordinary physical activity (such as walking and climbing stairs) does not cause angina. There is no history of previous symptoms of pain and no history of heart disease in the family. Physical examination of the chest, abdomen, and extremities revealed normal characteristics. Auscultation revealed normal heart sounds. Pulse and peripheral arteries/veins were normal. Blood pressure was within normal limits.” and the associated abbreviated text may read “Normal H and P”.

Yet further still, in an exemplary embodiment depicted in FIG. 11, a statement 610 in statement library 600 may be associated with and point to multiple statements 615, 620, and 630, for example, within the statement library itself. Statements which point to multiple statements will be used to form longer sentences, and/or paragraphs. However, statements, such as 615, 620, and 630 will remain available to be used as individual statements should a user desire.

Medical statements in the statement library may also be associated with a variety of external coding standards which will be used by specific hospitals, customers, and various database systems. Each of the statements in the statement library may be associated with a variety of coding standards, for example, SNOMED, LOINC, ACC, ICD9, CPT, HL7, CDA/XML, etc. Further, other customer specific internal coding standards and systems can be associated with statements in the statement library.

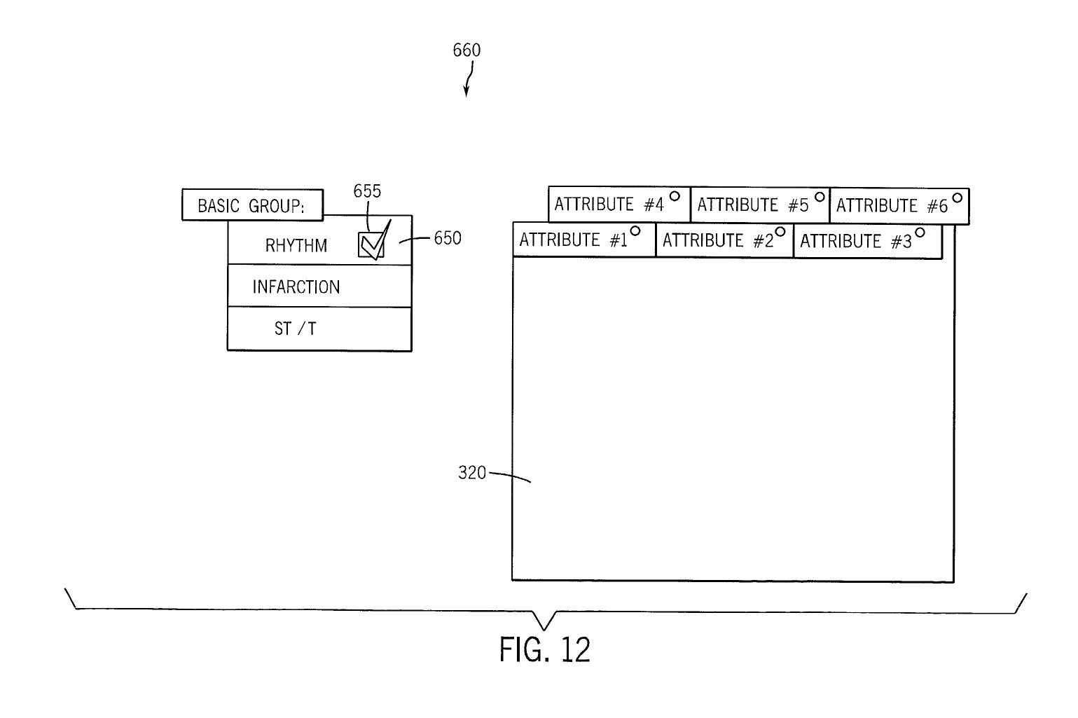

Yet further still, a user may search by groups of statements in the statement library. For certain searches, groups of statements are more useful to the user to be searched, because outcomes may be assessed more broadly. Search for a single statement in a group of clinical reports is typically not useful in determining a clinical or financial outcome. Too much granularity exists for a single statement to be useful. Accordingly groups of statements enable a user to assess an outcome much more broadly. The statement library browser may be used to set up search masks, by allowing a user to select a group of statements from the statement library in order to set up the search. For example, as depicted in FIG. 12, the user wishing to search statements in rhythm group 650 selects rhythm group 650 through a check box 655 in browser window 660. Once rhythm group 650 is selected, all the statements associated with rhythm group 650 will be displayed in statement list area 320. Accordingly, the user is not required to memorize the various combinations of statements or available statements in a specific group or relating to a specific clinical condition. This enables users to more practically and simplistically set up searches.

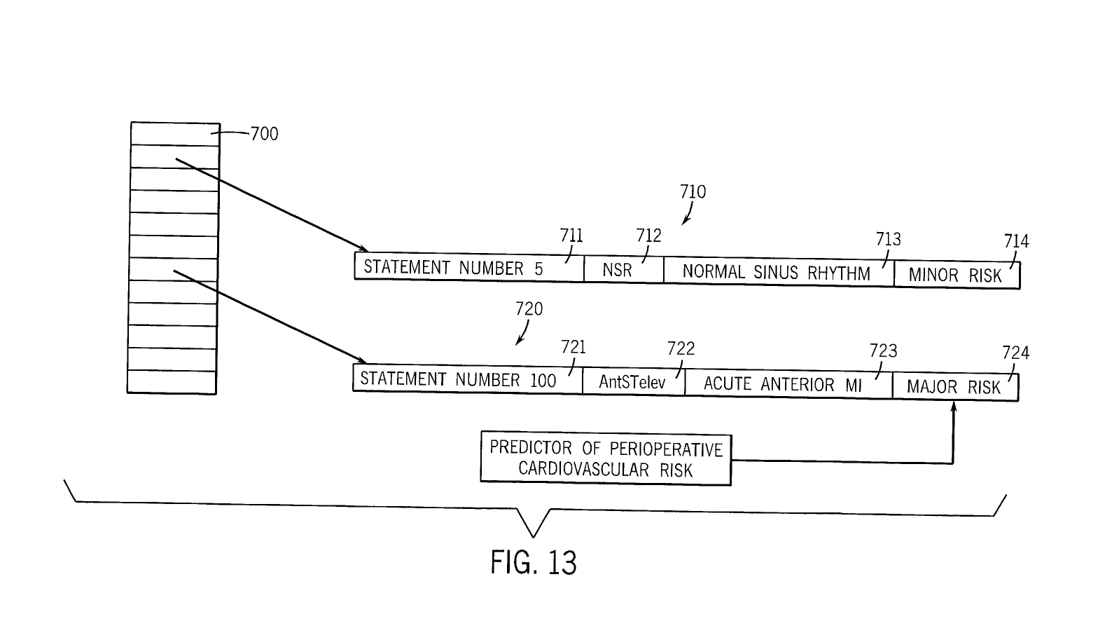

Referring now to FIG. 13, an exemplary diagram of a statement 710 and a statement 720 from statement library 700 are depicted. Statement 710 includes a statement number 711, a statement acronym 712, a statement text 713, and a diagnostic predictor 714. Similarly, statement 720 includes statement number 721, statement acronym 722, a statement text 723, and a diagnostic predictor 724. In an exemplary embodiment, statement library 700 may be initially configured with diagnostic predictors, such as, but not limited to, diagnostic predictors 714 and 724 or on selected statements in statement library 700. In an alternative embodiment, diagnostic predictions, such as, but not limited to, diagnostic predictions 714 and 724 may be configurable to the user to provide customized predictions and/or instructions.

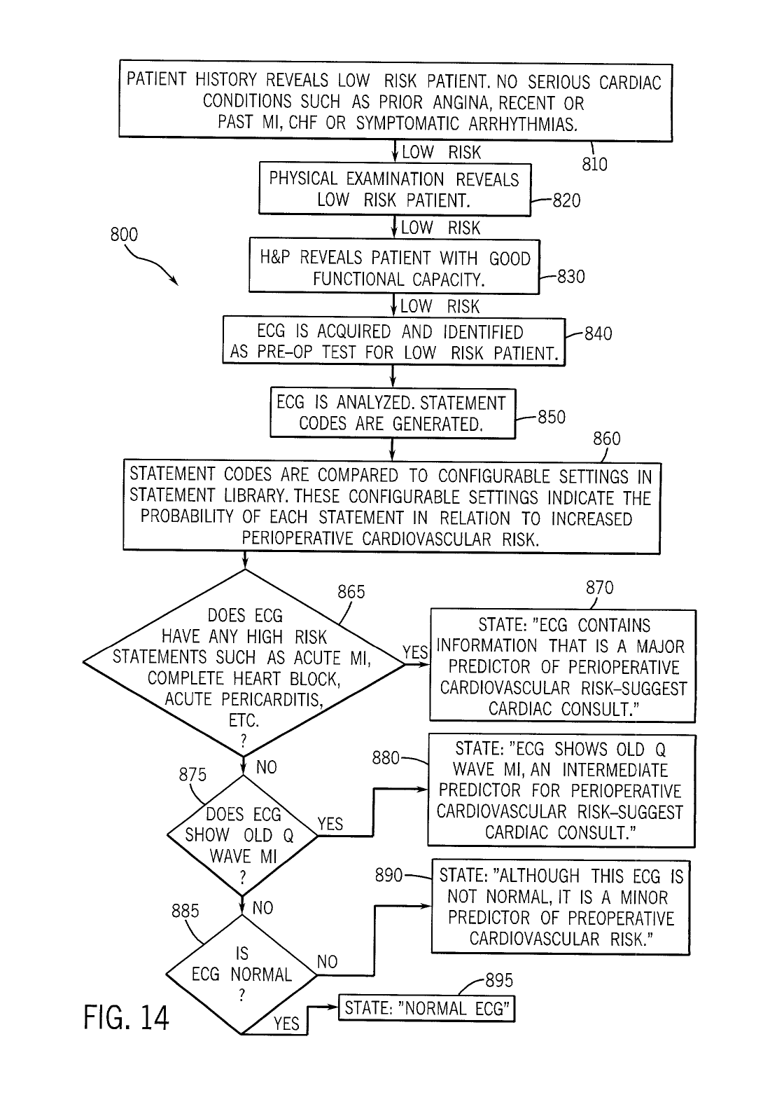

Referring to FIG. 14, a flow diagram depicting the steps of providing a semi-automated diagnosis using statement library 700 is depicted. Process 800 begins by having a patient history which, in the exemplary embodiment shown reveals a low risk patient with no serious cardiac conditions such as prior angina, recent or past myocardial infarction, CHF, or symptomatic arrhythmias (step 810). The patient then undergoes a physical examination, which in the exemplary embodiment shown reveals a low-risk patient (step 820). Cursory review of the patient history and physical examination reveals a patient with a good functional capacity (step 830). Next the patient is subject to an electrocardiogram, the ECG is identified as pre-op test for a low risk patient (step 840). The statement is automatically analyzed by a program, such as, but not limited to, the 12SL program as discussed earlier. Statement codes are automatically generated (step 850). The statement codes may be compared to configurable settings in the statement library or the statement codes that are generated may be associated with statements that have configured diagnostic classification settings, such as, but not limited to, the diagnostic classification settings of statement library 700 depicted in FIG. 13. The configurable settings indicate the probability of each statement in relation to increased perioperative cardiovascular risk (step 860). The report generated then undergoes an analysis including identifying whether the ECG has any high risk statements, such as acute Ml, complete heart blocks, acute pericarditis, etc. (step 865). If the ECG is identified with high risk statements, an indication is provided to the user that states, for example, “ECG contains information that is a major predictor of periopertive cardiovascular risk—suggest cardiac consult” (step 870). If step 865 does not identify high risk statements, the report is analyzed as to whether the ECG shows old Q wave myocardial infarction (step 875). If the ECG is identified as showing old Q wave myocardial infarction, the user is provided with a statement, for example, “ECG shows old Q wave MI, an intermediate predictor for perioperative cardiovascular risk—suggest cardiac consult” (step 880). If step 875 does not show old Q wave Ml, the program is configured to identify whether the ECG is normal. If the ECG is not normal, the user is provided with a statement, for example, “Although this ECG is not normal, it is a minor predictor of perioperative cardiovascular risk” (step 890). Finally, if the ECG is normal, the user is provided with a statement that states, for example, “Normal ECG” (step 895).

The use of additional attributes such as diagnostic classifications depicted in FIG. 13 and use of the method depicted in FIG. 14 provides for further simplification and automation of a cardiovascular or other medical condition assessment.

While the exemplary embodiments disclosed refer to a medical statement library, the invention may also be applied to statement libraries of many different sorts and applications. Further, while the exemplary embodiments refer to specific exemplary statements, the invention should be interpreted much more broadly, the embodiments may encompass statements having any of a variety of forms and may be configured in any of a variety of ways having various source of attributes, statement numbers, statement text, etc. Further still, those who have skill in the art will recognize that the invention is applicable with many different hardware configurations, software architectures, communications protocols, databases, organizations, and/or processes.

While the detailed drawings, specific examples, and particular formulations given describe exemplary embodiments, they serve the purpose of illustration only. The configurations depicted and described may differ depending on the chosen performance characteristics, and types of statement libraries utilized. For example, the statement text, and/or attributes used may differ. The systems shown and described are not limited to the precise details and conditions disclosed. Furthermore, other substitutions, modifications, changes, arid omissions may be made in the design, operating functionality, and arrangement of the exemplary embodiments without departing from the scope of the invention as expressed in the appended claims.

What is claimed is:

1. A method of organizing a statement library, the statement library including a plurality of statements each statement having statement text, a statement number, and a statement acronym, the method comprising:
associating each statement to at least one statement grouping;
associating each statement to a plurality of statement attributes;
associating keywords to at least one of statement groupings, and statement numbers; and
associating each statement with other statements.

2. The method of claim 1, further comprising: providing placeholders in a plurality of statements.

3. The method of claim 1, further comprising enabling user initiated changes in font within each statement.

4. The method of claim 1, further comprising:
providing reference information in a plurality of statements.

5. The method of claim 1, further comprising:
providing a hyperlink in a plurality of statements.

6. The method of claim 1, further comprising:
associating a part of speech with a plurality of statements.

7. The method of claim 1, further comprising:
associating grammatical characteristics with a plurality of statements.

8. The method of claim 1, further comprising:
associating an acronym with a plurality of statements.

9. The method of claim 1, further comprising:
associating a diagnostic predictor with a plurality of statements.

10. A method of interacting with a cardiographic statement library, the cardiographic statement library including a plurality of statements each statement having statement text, a statement number, and a statement acronym, the method comprising:
providing a keyword;
accessing a statement grouping associated with the keyword; and
selecting a statement from the statement grouping.

11. The method of claim 10, further comprising:
accessing a minor grouping associated with the grouping.

12. The method of claim 10, further comprising:
providing font information to the statement.

13. The method of claim 10, further comprising:
accessing reference information associated with the statement.

14. The method of claim 10, further comprising:
accessing a hyperlink associated with the statement.

15. The method of claim 10, further comprising:
providing a statement including a placeholder.

16. The method of claim 10, further comprising:
providing information relating to the statement at the placeholder location in the statement.

17. The method of claim 10, further comprising:
providing abbreviated statement text.

18. A method of generating clinical report text, comprising:
accessing a first medical statement from a statement library the first medical statement including a first grammatical characteristic identifier;
accessing a second medical statement from the statement library the second medical statement including a second grammatical characteristic identifier;
accessing the grammatical characteristic identifiers of the first and second medical statements; and
assembling the first medical statement with the second medical statement according to the grammatical characteristic identifiers of the first medical statement and the second medical statement, into a text block.

19. The method of claim 18, further comprising:
associating measurement data with the first medical statement.

20. The method of claim 18, further comprising:
incorporating reason codes into the text block.

21. The method of claim 18, further comprising:
associating the first and second medical statements with a template configured to guide assemblage of the text block.

22. The method of claim 18, further comprising:
constraining selection of the second medical statement according to a template configured to guide assemblage of the text block.

23. The method of claim 22, further comprising:
constraining the selection of the second medical statement from a specific grouping according to the template.

24. The method of claim 22, further comprising:
constraining the selection of the second medical statement according to the grammatical characteristics of the third medical statement as specified in the template.

25. The method of claim 22, further comprising:
constraining the selection of the second medical statement according to an explicit statement list as specified by the template.

26. A method of generating a clinical report through a computer user interface, comprising:
selecting a first medical statement from a medical statement library;
providing to the user access to a plurality of filtered medical statements based on the first medical statement, the filter being based on at least one of a grammatical characteristic of the first medical statement, a keyword, an acronym, and a grouping identifier; and
selecting a second medical statement from the plurality of filtered medical statements.

27. The method of claim 26, further comprising:
completing automatically a partial identifier entered by a user.

28. The method of claim 26, further comprising:
providing access to the complete statement library upon request by a user and thereby replacing the plurality of filtered medical statements.

29. The method of claim 26, further comprising:
providing to the user access to a further filtered list of medical statements derived from the plurality of filtered medical statements based upon a grouping identifier provided by a user.

30. A method of making a clinical assessment comprising:
generating a plurality of medical statements from a statement library based on clinical measurements, at least some of the medical statements in the statement library being associated with a diagnostic predictor;
analyzing the diagnostic predictors from the plurality of medical statements; and
providing, as an output, a clinical assessment based on the analysis of the diagnostic predictors.

31. The method of claim 30, wherein the plurality of medical statements are automatically generated.

32. The method of claim 30, further comprising generating a plurality of medical statements based on patient history information.

33. The method of claim 30, further comprising:
generating a plurality of medical statements based on physical examination information.

34. The method of claim 30, wherein the clinical assessment is a cardiovascular assessment.

35. The method of claim 30, wherein the medical statements are cardiovascular medical statements.
